(19) United States
(12) Patent Application Publication
(10) Pub. No.: US 2016/0362637 A1
(43) Pub. Date: Dec. 15, 2016

(54) COMPOSITIONS AND METHODS FOR THE REMOVAL OF PAINTS, VARNISHES, STAINS OR GRAFFITI

(71) Applicant: Timothy B. Jeter, Roanoke, VA (US)

(72) Inventor: Timothy B. Jeter, Roanoke, VA (US)

(21) Appl. No.: 15/067,286

(22) Filed: Mar. 11, 2016

Related U.S. Application Data
(60) Provisional application No. 62/132,390, filed on Mar. 12, 2015.

(51) Int. Cl. C11D 3/18; C09D 9/00; C09D 9/04; C11D 1/22; C11D 3/20

(52) U.S. Cl. CPC C11D 3/188; C11D 1/22; C11D 3/2068; C09D 9/04; C09D 9/005

(57) ABSTRACT

Certain compositions are described that can be used to remove graffiti, paint or other materials from a surface. In some instances, the composition may comprise a cyclic terpene, a glycol ether and one or more surfactants. The compositions can be environmentally friendly and have low toxicity.

### PRIORITY APPLICATION

This application claims priority to, and the benefit of, U.S. Provisional Application No. 62/132,390 filed on Mar. 12, 2015, the entire disclosure of which is hereby incorporated herein by reference for all purposes.

### TECHNOLOGICAL FIELD

This application is related to compositions and formulations which can be used to remove paints, varnishes, stains or graffiti. More particularly, certain formulations are directed to compositions comprising or consisting essentially of or consisting of a cyclic terpene in combination with a glycol ether and optionally a surfactant and other components.

### BACKGROUND

U.S. Pat. No. 5,167,853 is directed to stripping compositions for paints, varnishes and lacquers that include certain solvents and water.

U.S. Pat. No. 5,484,487 is directed to cleansers that include ethylene glycol n-butyl ether, acetone, dibasic ester, and optionally water in specified proportions.

U.S. Pat. No. 6,153,573 is directed to predominantly aqueous compositions for plasticizing or softening paint.

### SUMMARY

In a first aspect, a composition comprises about 10 weight percent to about 75 weight percent of a cyclic terpene comprising ten carbon atoms, about 10 weight percent to about 75 weight percent of a glycol ether, about 3 weight percent to about 30 weight percent of a surfactant; and about 5 weight percent to about 30 weight percent water.

In certain embodiments, the cyclic terpene comprises d-limonene, dipentene and mixtures thereof. In some instances, the glycol ether is selected from the group consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether and diethylene glycol monomethyl ether and combinations thereof. In some embodiments, the surfactant comprises an alkylphenol ethoxylate. In other examples, the cyclic terpene consists essentially of d-limonene or dipentene. In some embodiments, the glycol ether consists essentially of diethylene glycol monobutyl ether. In other examples, the surfactant comprises nonylphenol 9 ethoxylate. In certain instances, the composition may comprise an additional component selected from the group consisting of an emulsifier, another surfactant and a detergent. In some embodiments, the cyclic terpene is present at about 35-45% by weight and the glycol ether is present at about 50-60% by weight. In other embodiments, the cyclic terpene is present at about 40% by weight and the glycol ether is present at about 55% by weight.

In an additional aspect, a composition consisting essentially of about 10 weight percent to about 75 weight percent of a cyclic terpene comprising ten carbon atoms, about 10 weight percent to about 75 weight percent of a glycol ether, and about 3 weight percent to about 30 weight percent surfactant is provided. In some instances, the cyclic terpene comprises d-limonene, dipentene and mixtures thereof. In other instances, the glycol ether is selected from the group consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether and diethylene glycol monomethyl ether and combinations thereof. In certain examples, the surfactant comprises an alkylphenol ethoxylate. In other examples, the cyclic terpene consists essentially of d-limonene or dipentene. In further embodiments, the glycol ether consists essentially of diethylene glycol monobutyl ether. In certain instances, the surfactant comprises nonylphenol 9 ethoxylate. In additional examples, the composition can comprise an additional component selected from the group consisting of an emulsifier, another surfactant and a detergent. In some examples, the cyclic terpene is present at about 35-45% by weight and the glycol ether is present at about 45-55% by weight. In further embodiments, the cyclic terpene is present at about 40% by weight, the glycol ether is present at about 55% by weight and the surfactant is present at about 5% by weight.

In another aspect, a composition consisting of about 10 weight percent to about 75 weight percent of a cyclic terpene comprising ten carbon atoms, about 10 weight percent to about 75 weight percent of a glycol ether, and about 3 weight percent to about 30 weight percent surfactant.

In certain examples, the cyclic terpene comprises d-limonene, dipentene or a mixture of d-limonene and dipentene. In other examples, the glycol ether is selected from the group consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether and diethylene glycol monomethyl ether and combinations thereof. In some examples, the surfactant is an alkylphenol ethoxylate. In certain embodiments, the cyclic terpene consists of d-limonene or dipentene. In some instances, the glycol ether consists of diethylene glycol monobutyl ether. In other examples, the surfactant comprises nonylphenol 9 ethoxylate. In some embodiments, the composition may comprise an additional component selected from the group consisting of an emulsifier, another surfactant and a detergent. In certain instances, the cyclic terpene is present at about 35-45% by weight and the glycol ether is present at about 45-55% by weight. In other instances, the cyclic terpene is d-limonene present at about 40% by weight, the glycol ether is diethylene glycol monobutyl ether present at about 55% by weight and the surfactant is nonylphenol 9 ethoxylate present at about 5% by weight.

In an additional aspect, a method of removing graffiti from a surface comprises disposing a composition on the graffiti to thereby remove the graffiti, the composition comprising a glycol ether, a surfactant and a cyclic terpene comprising ten carbon atoms.

In certain instances, the method comprises pressure washing the graffiti using the composition. In other embodiments, the method comprises heating the graffiti prior to disposing the composition on the graffiti. In further examples, the method comprises heating the composition prior to disposing the composition on the graffiti. In some examples, the method comprises configuring the composition to comprise about 55 weight percent glycol ether, about 40 weight percent cyclic terpene and 5 weight percent surfactant. In further instances, the method comprises selecting the cyclic terpene to be d-limonene or dipentene or mixtures thereof. In some examples, the method comprises selecting the glycol ether to be diethylene glycol monobutyl ether. In additional examples, the method comprises selecting the surfactant to be nonylphenol 9 ethoxylate. In some embodiments, the composition further comprises water. In other embodiments, the method comprises wiping the disposed composition from the surface to remove the graffiti or brushing the surface with the disposed composition to remove the graffiti.

In another aspect, a method of facilitating removal of graffiti, varnish or paint from a surface comprises providing a composition as described herein and providing instructions for using the composition of claim 1 to remove the graffiti, varnish or paint from the surface. The composition may be, for example, a composition comprising about 10 weight percent to about 75 weight percent of a cyclic terpene comprising ten carbon atoms, about 10 weight percent to about 75 weight percent of a glycol ether, about 3 weight percent to about 30 weight percent of a surfactant, and optionally about 5 weight percent to about 30 weight percent water. In other instances, the composition may consist essentially of about 10 weight percent to about 75 weight percent of a cyclic terpene comprising ten carbon atoms, about 10 weight percent to about 75 weight percent of a glycol ether, and about 3 weight percent to about 30 weight percent surfactant. In other instances, the composition may consist of about 10 weight percent to about 75 weight percent of a cyclic terpene comprising ten carbon atoms, about 10 weight percent to about 75 weight percent of a glycol ether, and about 3 weight percent to about 30 weight percent surfactant. In certain examples, the method comprises providing one or more of a wire brush, a second composition, or providing an accessory device for use with the provided composition.

In another aspect, a kit comprises one or more of the compositions described herein and instructions for using the composition to remove graffiti, paint or varnish on a surface. The composition of the kit may be, for example, a composition comprising about 10 weight percent to about 75 weight percent of a cyclic terpene comprising ten carbon atoms, about 10 weight percent to about 75 weight percent of a glycol ether, about 3 weight percent to about 30 weight percent of a surfactant, and optionally about 5 weight percent to about 30 weight percent water. In other instances, the composition of the kit may consist essentially of about 10 weight percent to about 75 weight percent of a cyclic terpene comprising ten carbon atoms, about 10 weight percent to about 75 weight percent of a glycol ether, and about 3 weight percent to about 30 weight percent surfactant. In other instances, the composition of the kit may consist of about 10 weight percent to about 75 weight percent of a cyclic terpene comprising ten carbon atoms, about 10 weight percent to about 75 weight percent of a glycol ether, and about 3 weight percent to about 30 weight percent surfactant. In certain instances, the kit may also comprise one or more of a wire brush, an accessory device, and a second composition.

In an additional aspect, a graffiti removal system may comprise one or more of the compositions described herein and any accessory device for use with the composition(s). The composition of the system may be, for example, a composition comprising about 10 weight percent to about 75 weight percent of a cyclic terpene comprising ten carbon atoms, about 10 weight percent to about 75 weight percent of a glycol ether, about 3 weight percent to about 30 weight percent of a surfactant, and optionally about 5 weight percent to about 30 weight percent water. In other instances, the composition of the system may consist essentially of about 10 weight percent to about 75 weight percent of a cyclic terpene comprising ten carbon atoms, about 10 weight percent to about 75 weight percent of a glycol ether, and about 3 weight percent to about 30 weight percent surfactant. In other instances, the composition of the system may consist of about 10 weight percent to about 75 weight percent of a cyclic terpene comprising ten carbon atoms, about 10 weight percent to about 75 weight percent of a glycol ether, and about 3 weight percent to about 30 weight percent surfactant. In certain embodiments, the accessory device comprises one or more of a wire brush, sand paper, abrasive media, a heat gun, a pressure washer or other devices.

Additional aspects, examples, embodiments and configurations are described in more detail below.

### BRIEF DESCRIPTION OF THE FIGURES

Certain illustrative compositions are described herein with reference to the accompanying figures in which:

FIG. 1 is a photograph showing graffiti on a street surface prior to treatment; and

FIG. 2 is a photograph showing the graffiti on the street surface after treatment.

### DETAILED DESCRIPTION

Certain compositions are described herein which are effective to remove paint(s), varnishes, stains or graffiti from surfaces. In certain instances, the compositions may have low or no toxicity to humans or other animals, may be non-flammable and may generally be environmentally friendly. The composition can be biodegradable and can be applied for the removal of polymeric coatings or stains or graffiti derived thereof. It is a substantial attribute that the compositions described herein may comprise only two or three components (which are typically environmentally friendly) and can be substantially free of organic (conventionally aggressive) solvents to include, for example, halogenated, flammable, toxic and other harmful solvents.

Historically the removal of paints and coatings had been achieved with chemical methodologies that had flammable and/or toxic and/or corrosive attributes. To achieve greater safety the use of materials with lower hazard constituents was initiated. Prior art describes the incorporation of lower hazard but somewhat arcane materials which do not contribute to economy.

Certain compositions described herein also have a desired attribute of having a flashpoint of about 130 degrees F. and include constituents with very low potential for toxicity. Further, superior performance has been demonstrated in trials versus other low hazard compositions which are described in other patents. Rheological enhancement can be achieved through a novel interaction of components and is of particular use when the composition is applied to vertical surfaces. Of interest with regard to potential municipal applications are the described economic features and low hazard properties which would reduce risk and cost to governments.

In addition to the properties described, the compositions can be water soluble (or water rinsable) to permit the composition and any deconstructed coating or stain to be be rinsed (lifted) with a stream of water or water bearing sponge, rag or other abraiding mechanism after application. In some configurations, functionality is realized by the solvation, plasticizing and anti-adhering action of the compositions to effect deconstruction of the coating or stain. In some embodiment, a viscosity of about 40-60 cPs may be achieved through the synergistic interaction of affordable and common materials described as being present in various formulations. If desired, the achieved viscosity can be selected to permit vertical cling with reduced sheeting of the liquid, e.g., the formulation can resist sliding down a vertical surface comprising the graffiti once it is disposed onto the graffiti.

In certain instances, the compositions do not use toxic or flammable substances including, for example, methylene chloride, methyl ethyl ketone, methanol, acetone, benzene, toluene, xylene, chlorobenzene, trichloroethanes and trichloroethylene. For example, the compositions may be substantially free or entirely free of one or more of methylene chloride, methyl ethyl ketone, methanol, acetone, benzene, toluene, xylene, chlorobenzene, trichloroethanes and trichloroethylene. In some instances, the compositions are halogen free or substantially halogen free.

In certain instances, the composition may comprise a first component comprising nine to twenty (20) carbon atoms, more particularly nine to eleven carbon atoms, e.g., ten carbon atoms. In certain instances, the first component may comprise ten carbons and be present in cyclic form at least for some portion of the ten carbon molecule. For example, the ten carbon molecule may comprise a single ring or more than a single ring. Illustrative examples of the first component include, but are not limited to, ten carbon terpenes such as, for example, limonene, limonene derivatives including limonene substituted with one or more of non-carbon atoms such as, for example, oxygen and nitrogen at one or more sites, dipentene, substituted dipentenes comprising one or more non-carbon atoms such as oxygen and nitrogen, higher terpene and dipentene analogues including but not limited to sesquiterpenes such as cadenene and mixtures of limonene (or limonene derivatives) and dipentene (or dipentene derivatives). While the exact weight percentage of the first component in the composition may vary depending on which other components are present, illustrative weight percentages of the first component include, but are not limited to, 10%-75%, 15%-75% 20%-75%, 25%-75%, 30%-75%, 35%-75%, 40%-75%, 45%-75%, 50%-75%, 55%-75%, 60%-75%, 65%-75%, 70%-75%, 10%-60%, 10%-50%, 10%-40%, 10%-30%, 10%-20%, 20%-70%, 20%-60%, 20%-50%, 20%-40%, 20%-30%, 30%-70%, 30%-60%, 30%-50%, 30%-40%, 40%-70%, 40%-60%, 40%-50%, 50%-70%, 50%-60% or 60%-70% by weight.

In some instances, the first component may be a naturally occurring compound comprising ten carbon atoms or non-synthetic compound comprising ten carbon atoms. For example, limonene and certain limonene derivatives exist or can be extracted from the peels of limes, lemons, oranges, etc. In some instances, the naturally occurring compound may exist in one enantiomeric form, which can racemize to another compound or form, e.g., d-limonene can racemize to dipentene, when combined with other components or under certain conditions.

In some configurations, the first component may be mixed with a second component comprising one or ether or glycol ether compounds. In certain embodiments, the ether may comprise one or more unsaturation sites. For example, the second component may comprise one or more glycol ethers including, for example, those based on ethylene glycol, diethylene glycol and other glycols. Illustrative glycol ethers which may be present as or in the second component include, but are not limited to, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether and benzyl ether ethoxylates. While the exact weight percentage of the second component in the composition may vary depending on which other components are present, illustrative weight percentages of the second component include, but are not limited to, 5%-75%, 10%-75% 20%-75%, 25%-75%, 30%-75%, 35%-75%, 40%-75%, 45%-75%, 50%-75%, 55%-75%, 60%-75%, 65%-75%, 70%-75%, 5%-60%, 5%-50%, 5%-40%, 5%-30%, 5%-20%, 5%-15%, 5%-10%, 10%-60%, 10%-50%, 10%-40%, 10%-30%, 10%-20%, 10%-15%, 20%-70%, 20%-60%, 20%-50%, 20%-40%, 20%-30%, 30%-70%, 30%-60%, 30%-50%, 30%-40%, 40%-70%, 40%-60%, 40%-50%, 50%-70%, 50%-60% or 60%-70% by weight. In some instances, the glycol ether component may be present in a major amount, e.g., at 50% by weight or more, in the composition.

In certain embodiments, the compositions described herein may be a binary composition in that only the first component and the second component are present. For example, the composition may comprise a suitable terpene and a suitable glycol ether and be substantially free of all other compounds while still being suitable for use in removing paints, varnishes, graffiti, etc. from surfaces.

In certain instances, an optional surfactant, emulsifier or detergent may be present in combination with the first and second components to provide a ternary mixture. In some instances, the surfactant may be an ionic surfactant or a non-ionic surfactant. In other configurations, the surfactant may take the general form of an alkylphenol ethoxylate or a phenol derivative, e.g., a para-substituted phenol derivative comprising a hydrocarbon side chain which may be saturated or unsaturated and an ethoxylate group which may be present one or more times. While the exact side chain may vary, the side chain typically comprises about six to about ten carbon atoms, e.g., about eight to ten carbon atoms or nine to ten carbon atoms or nine carbon atoms. Similarly, the ethoxylate group may be present from 1 to 10 times, e.g., present as a —(OCH₂CH₂)ₙOH group where n is 1-20, 2-20, 3-20, 4-20, 5-20, 6-20, 7-20, 8-20, 9-20, 10-20 or any value in between these illustrative values. If desired, blends or mixtures of surfactants, emulsifiers or detergents may also be used.

While other components could be added (as noted below), in certain instances, the composition may consist essentially of a first component, a second component and a surfactant, emulsifier or detergent. For example, the composition may consist essentially of d-limonene, a glycol ether and a surfactant. In other instances, the composition may consist essentially of dipentene, a glycol ether and a surfactant. In additional configurations, the composition may consist essentially of a ten carbon cyclic terpene, a diethylene glycol ether and a surfactant. In other configurations, the composition may consist essentially of a ten carbon cyclic terpene, diethylene glycol monoethyl ether and a surfactant. In some configurations, the composition may consist essentially of limonene or dipentene (or mixtures of them), diethylene glycol monoethyl ether and a surfactant. In yet other instances, the composition may consist essentially of limonene or dipentene (or mixtures of them), diethylene glycol monoethyl ether and a non-ionic surfactant.

In certain configurations, the compositions may comprise about 10%-75% by weight of a terpene hydrocarbon with 10 carbon atoms, about 10%-75% by weight of a glycol ether, and about 2%-20% of emulsifying surfactants. If desired, about 5%-30% water may also be present. In some instances, the compositions consist essentially of about 10%-75% by weight of a terpene hydrocarbon with 10 carbon atoms, and about 10%-75% by weight of a glycol ether. In other instances, the compositions consist essentially of about 10%-75% by weight of a terpene hydrocarbon with 10 carbon atoms, about 10%-75% by weight of a glycol ether, and about 2%-20% of emulsifying surfactants. If desired, the various weight percentages of the compounds used can be selected to provide a desired flash point for the compositions. For example, the compositions may have a flash point at about 130 degrees F.

In certain instances, the composition may comprise a terpene hydrocarbon of ten carbon atoms present between about 10% to about 75% weight percent (to include dipentene and d-limonene and mixtures thereof), a glycol ether consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether or diethylene glycol monomethyl ether present at about 20% to 75% by weight, and a surfactant or surfactant mixture comprising one or more of a nonylpenol ethoxylate with an ethoxylate number between 4 and 20, an alkyl ethoxylate with ethoxylate number between 4 and 20, a surfactant derived from dodecylbenzene sulfonic acid in the form of its conjugate base or an amphoteric surfactant. If desired, water or other components may also be present. The particular weight percentages of each component can be selected, for example, to ensure the flash point of the composition is 130 degrees F. or above.

In some instances, the composition may consist essentially of a terpene hydrocarbon of ten carbon atoms present between about 10% to about 75% weight percent (to include dipentene and d-limonene and mixtures thereof), a glycol ether consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether or diethylene glycol monomethyl ether present at about 20% to 75% by weight, and a surfactant or surfactant mixture comprising one or more of a nonylpenol ethoxylate with an ethoxylate number between 4 and 20, an alkyl ethoxylate with ethoxylate number between 4 and 20, a surfactant derived from dodecylbenzene sulfonic acid in the form of its conjugate base or an amphoteric surfactant. The particular weight percentages of each of the three components present can be selected, for example, to ensure the flash point of the composition is 130 degrees F. or above.

In certain embodiments, the particular form of the formulation can vary depending on the desired application method. For example, where the composition is to be brushed on, painted on, added with a rag, towels, etc. the composition may be present in liquid form in a container that permits access, e.g., a container similar to a paint can. In other instances, the composition can be sprayed onto a surface by placing the composition in a spray bottle or similar device. In yet additional configurations, the composition can be used in aerosol form with one or more propellants or other gases or materials to assist in spraying the composition onto a surface. In some instances, the composition may be packaged into a vial, tear open package or the like, and a user can dilute the material into water or apply it directly to the surface. If desired, the composition can be packaged in the form of a kit including the composition, a spray bottle and optional instructions for using the composition to remove graffiti or similar materials from the surface. The bottle may comprise dilution marks to facilitate preparing a particular concentration prior to use.

In some configurations, the composition can be pre-disposed on a surface where paint, varnish or graffiti may be added to reduce the sticking of the material to the surface. For example, pre-application of the composition to a clean surface can provide for a residue on the surface to reduce the adherence of successive disposed materials to the surface. The composition, or some component(s) thereof, may act as a barrier to reduce sticking or adherence to the surface. Pre-application may be particularly useful to deter sticking of bird droppings, animal droppings, tree sap, insect secretions or excretions, chewing gum or other materials which can be difficult to remove from surfaces once adhered.

In certain embodiments, the compositions described herein may be heated prior to use, the surface may be heated prior to use or both. Without wishing to be bound by any particular theory, heating of the composition to a desired temperature, e.g., above 100 deg. F, can act to activate the composition and enhance its removal of the unwanted material. Heating of the composition and/or surface may be particularly effective where adhesive residue remains on the surface, e.g., where a bumper sticker or other adhesive backed items have been placed on the surface and needs removed.

The compositions described herein can be used to remove unwanted materials on horizontal and vertical surfaces. In use of the compositions, the compositions can be sprayed on, coated on, or otherwise placed on a material to be removed from a horizontal surface or a vertical surface. The composition may be permitted to reside for some period on the material to permit loosening of the material from the surface. If desired, a wire brush, abrasive means or other physical devices can be used to assist removal of the material on the surface. In some instances, the composition can be used in combination with high pressure sprays, e.g., from a pressure washer, to assist in removal of the material from the surface. For example, the composition can be mixed (marginal feasibility but worth addressing) with the high pressure spray from a fluid reservoir or may first be disposed (dispersed) on the material to be removed followed by pressure washing.

In certain instances, the compositions described herein are gentle to underlying surfaces and generally do not result in destruction or damage to the surfaces after use. For example, stone surfaces, paved surfaces, drywall, hardwood floors, concrete board, etc. can be cleaned with the compositions without any damage to the underlying surface. In some instances, the composition can be used as a pre-primer cleaning prior to painting or staining the surface. For example, the composition can be coated onto hardwood floors to remove polyurethane prior to recoating of the hardwood floors. Similarly, precious materials or surfaces such as jewelry, silverware, knives, etc. can also be cleaned without damaging the metal surfaces. If desired, cleaning may be accompanied by one or more physical perturbations including heat, sound, air or other perturbations which can assist in the cleaning process using the compositions.

In certain embodiments, the viscosity of the compositions described herein can be selected such that the compositions are retained at a disposed area after application of the compositions to a vertical surface. For example, by configuring the composition to have a viscosity of 40-60 cPs or more, reduced sheeting and rudimentary vertical cling can be achieved. If desired, a first aliquot of the material with a high viscosity, e.g., 40-60 cPs, can be disposed followed by application of the material with a lower viscosity, e.g., 30-35 cPs. In addition, the viscosity of the disposed composition can be altered by first disposing the material at ambient temperature and then heating the surface+disposed material. Heating of the material can be accomplished using suitable methods and devices including, but not limited to, a heat gun, heating packs or pads, and other heating devices and methods.

In certain instances, the compositions described herein can be present in a kit. The kit may comprise, for example, one or more of the compositions described herein and instructions for use. If desired, the kit may also comprise a wire brush, abraiding mechanisms, sand paper, or other accessory devices. Further, the kit may include other compositions including different cleaning agents such as acids, bases, detergents or other materials as desired. In some instances, the kit may comprise a plurality of compositions of different concentrations to permit an end user to select a particular concentration for use. For example, the kit may comprise a series of individually packaged compositions (which may be the same formulation or different) present at different concentrations.

In some examples, a method of facilitating removal or graffiti, varnish or paint on a surface can include providing one or more of the compositions described herein and optionally providing instructions for using the composition to remove the graffiti, varnish or paint from the surface. If desired, the method may also comprise providing one or more accessory devices, e.g., a wire brush, sand paper, etc. In certain instances, the method may also comprise providing an additional composition or material.

Certain specific examples are described below to illustrate some of the novel features of the compositions and formulations described herein.

### EXAMPLE 1

A composition can be produced that include 30% by weight d-limonene, about 30%, 40% by weight diethylene glycol monobutyl ether, 8% by weight, nonylphenol 9 ethoxylate, 4% by weight sodium dodecylbenzene sulfonic acid and 18% by weight water. The composition can be used to remove graffiti, paint or other materials from vertical and/or horizontal surfaces.

### EXAMPLE 2

A composition was produced that included 55% by weight diethylene glycol monobutyl ether, 40% by weight d-limonene, and 5% by weight nonylphenol 9 ethoxylate.

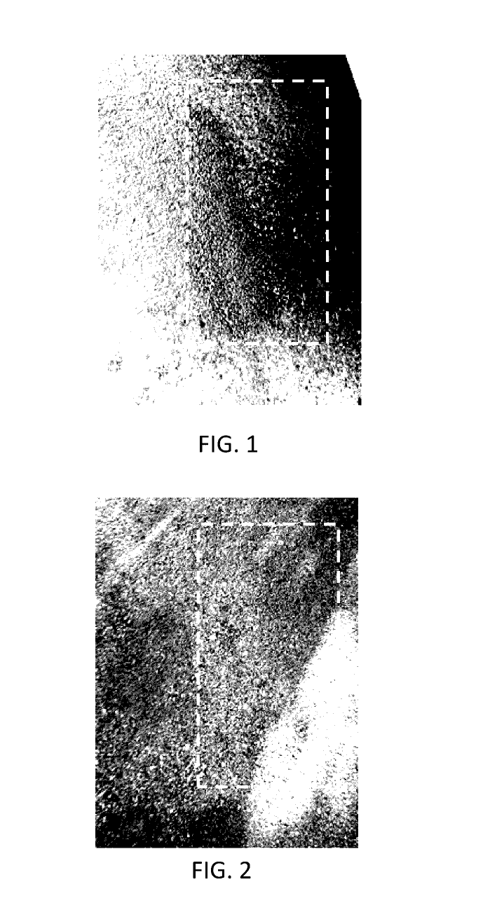

In order to test the composition, the composition was evaluated for its ability to remove spray paint. Referring to FIG. 1, graffiti is shown as being present on a street surface. A spray painted “h” is shown in the dotted box in FIG. 1.

The composition of this example was sprayed onto the “h” and with abraiding by a wire brush followed by water rinsing, the graffiti was lifted from the pavement. As shown in the dotted box of FIG. 2, substantially all of the “h” was removed after application of the composition.

### EXAMPLE 3

The composition of Example 2 was used to test its ability to remove layers of paint on an antique chair. The product was effective at removing the older layers of paint without having to use resort to organic solvent (toxic or flammable) strippers.

### EXAMPLE 4

The composition of Example 2 was applied to a vertical surface of a door which included spray paint graffiti. The product was able to remove the graffiti from the vertical surface.

### EXAMPLE 5

The composition of Example 2 was used to remove soot and fluids from propeller aircraft. The product was sprayed onto downstream fuselage of the propeller aircraft and removed the fluids and soot.

When introducing elements of the aspects, embodiments and examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A composition comprising:
about 10 weight percent to about 75 weight percent of a cyclic terpene comprising ten carbon atoms;
about 10 weight percent to about 75 weight percent of a glycol ether;
about 3 weight percent to about 30 weight percent of a surfactant; and
about 5 weight percent to about 30 weight percent water.

2. The composition of claim 1, in which the cyclic terpene comprises d-limonene, dipentene and mixtures thereof.

3. The composition of claim 2, in which the glycol ether is selected from the group consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether and diethylene glycol monomethyl ether.

4. The composition of claim 3, in which the surfactant comprises an alkylphenol ethoxylate.

5. The composition of claim 1, in which the cyclic terpene consists essentially of d-limonene or dipentene.

6. The composition of claim 5, in which the glycol ether consists essentially of diethylene glycol monobutyl ether.

7. The composition of claim 6, in which the surfactant comprises nonylphenol 9 ethoxylate.

8. The composition of claim 1, further comprising an additional component selected from the group consisting of an emulsifier, another surfactant and a detergent.

9. The composition of claim 1, in which the cyclic terpene is present at about 35-45% by weight and the glycol ether is present at about 50-60% by weight.

10. The composition of claim 1, in which the cyclic terpene is present at about 40% by weight and the glycol ether is present at about 55% by weight.

11. A composition consisting essentially of:
about 10 weight percent to about 75 weight percent of a cyclic terpene comprising ten carbon atoms;
about 10 weight percent to about 75 weight percent of a glycol ether; and
about 3 weight percent to about 30 weight percent surfactant.

12. The composition of claim 11, in which the cyclic terpene comprises d-limonene, dipentene and mixtures thereof.

13. The composition of claim 12, in which the glycol ether is selected from the group consisting of ethylene glycol monobutyl ether, propylene glycol monobutyl ether, dipropylene glycol monobutyl ether, diethylene glycol monobutyl ether, propylene glycol monomethyl ether, dipropylene glycol monomethyl ether and diethylene glycol monomethyl ether.

14. The composition of claim 13, in which the surfactant comprises an alkylphenol ethoxylate.

15. The composition of claim 11, in which the cyclic terpene consists essentially of d-limonene or dipentene.

16. The composition of claim 15, in which the glycol ether consists essentially of diethylene glycol monobutyl ether.

17. The composition of claim 16, in which the surfactant comprises nonylphenol 9 ethoxylate.

18. The composition of claim 11, further comprising an additional component selected from the group consisting of an emulsifier, another surfactant and a detergent.

19. The composition of claim 11, in which the cyclic terpene is present at about 35-45% by weight and the glycol ether is present at about 45-55% by weight.

20. The composition of claim 11, in which the cyclic terpene is present at about 40% by weight, the glycol ether is present at about 55% by weight and the surfactant is present at about 5% by weight.

21-75. (canceled)
